(19) United States
(12) Patent Application Publication
(10) Pub. No.: US 2019/0387302 A1
(43) Pub. Date: Dec. 19, 2019

(54) Structure that prevents tangled wire

(71) Applicant: Hung To Li, SAN PO KONG (HK)

(72) Inventor: Hung To Li, SAN PO KONG (HK)

(21) Appl. No.: 16/011,623

(22) Filed: Jun. 18, 2018

(51) Int. Cl. H04R 1/10; H04R 1/08

(52) U.S. Cl. CPC H04R 1/1033; H04R 1/1016; H04R 1/08

(57) ABSTRACT

A structure that prevents tangled wire contains a wire body and N magnets provided on the wire body, wherein N≥1; the magnets are fixedly connected with the wire body. Due to the magnets which are mutually spaced from one another along the wire body, a user can simply wind the wire around the hand or any object that has a certain length, the wire will then form orderly windings automatically due to mutual magnetic attraction of the magnets. To straighten out the windings, pull apart two ends of the wire by a slight force sufficient to overcome the magnetic force to fully straighten out the wire.

### BACKGROUND OF THE INVENTION

The present invention relates to the technology of tangled wire prevention, and more specifically relates to a structure that prevents tangled wire.

In daily life, long wires such as those used with earphones, mobile phone chargers and hair dryers etc tend to tangle when they are straightened out for use or collected for storage. Tangled wires require a long time to untangle and thus causing much inconvenience during use. To solve this problem, several solutions are available in the prior art to prevent tangled wires. For example, a kind of earphone that can prevent tangled wire is available in the prior art, according to which a tangled wire prevention tube is sleeved on the wire of the earphone, and two clamps are provided on the tangled wire prevention tube. According to this structure, the long wire of the earphone can be wound on the tube, and the plugs can be fixed on the clamps. As a result, the complicated situation of a tangled earphone wire can be prevented. Although the above structure is simple, it is obviously inconvenient during use: it takes a long time to wound the wire section by section onto the tube, and it again takes a long time to straighten out the wire for use. Therefore, the structure is not efficient since it cannot enable the wire to be straightened out and collected quickly. A kind of tangling preventive earphone wire is also available in the prior art, comprising an earphone wire which has a rectangular cross section and Velcro® tapes evenly distributed on the surface of the earphone wire. The Velcro® tapes organize the earphone wire in an orderly manner to prevent its tangle and thus achieve the same purpose as a wire winding device. However, this kind of structure can only apply to a wire having a rectangular cross section, but not to the most commonly used wire that has a circular cross section. Therefore, this kind of structure does not have wide applicability. Also, the Velcro® tapes may have reduced adhesive ability after being used for a considerable period of time. As such, this kind of structure is also not durable for use and cannot provide stable adhesiveness.

### BRIEF SUMMARY OF THE INVENTION

In view of the aforesaid disadvantages now present in the prior art, a structure that prevents tangled wire is provided. The structure according to the present invention is structurally reasonable, simple and convenient to use, time and effort saving, and also allows wider applicability.

A structure that prevents tangled wire, comprising a wire body, characterized in that N magnets are provided on the wire body, wherein N≥1; the magnets are fixedly connected with the wire body.

The magnets are evenly distributed over the wire body, and are fixedly connected with the wire body through adhesion or embedment. In case of embedment, the magnets are removably connected with the wire body, a slot is provided on each of the magnets such that the wire body can be fitted thereinto so as to be fixed, and can also be disengaged therefrom for adjustment.

Preferably, the magnets are magnetic rings; each of the magnetic rings is provided with a center hole; the wire body passes through center holes of the magnets and connects with the magnets by adhesion. Further, an outer coating layer can be provided to wrap the wire body and the magnets such that the structure of the present invention has the same outer appearance as an ordinary wire. The outer coating layer can be made of plastics, rubber or nylon etc.

Preferably, the magnets can be formed as magnetic plates. The magnetic plates are connected with the wire body by adhesion. Further, an outer coating layer can be provided to wrap the wire body and the magnets such that the structure of the present invention has the same outer appearance as an ordinary wire. The outer coating layer can be made of plastics, rubber or nylon etc.

The wire body can be earphone wire, charger wire, hair dryer wire, or any electrical wire of general household appliances such as the wires for TV, audio devices, and electronic game devices.

Each of the magnets has a certain length to ensure sufficient magnetic force for connection but should not be too long to affect collection of the wire body. Preferably, each of the magnets has a length of 2-20 mm.

The magnets are disposed equidistantly on the wire body. A distance between two adjacent magnets is preferably 7-26 cm.

Preferably, apart from the magnets disposed on the wire body, the wire body is also provided with metal blocks or metal rings or metal coils that are attractable to the magnets. The metal blocks or metal rings or metal coils are arranged on the wire body in the same way as how the magnets are arranged on the wire body; preferably, the metal blocks or metal rings or metal coils and the magnets are disposed alternately along a length of the wire body, such that any magnet and any one or more metal blocks or metal rings or metal coils adjacent thereto are mutually attracted.

Operating principle of the present invention: Due to the magnets (or alternate arrangement of magnets and metal blocks or metal rings or metal coils) which are mutually spaced from one another (preferably spaced apart equidistantly) along the wire of the present structure, a user can simply wind the wire around the hand or any object that has a certain length during use, the wire will then form orderly windings automatically due to mutual magnetic attraction of the magnets (or magnetic attraction between magnets and metal blocks or metal rings or metal coils). To straighten out the windings, pull apart two ends of the wire by a slight force sufficient to overcome the magnetic force to fully straighten out the wire.

The present invention further provides another structure that prevents tangled wire which comprises a magnetic wire body. Preferably, the magnetic wire body has a covering made of a material being a mixture of magnetic powder and plastic.

The present invention further provides a wired earphone device with a microphone with the structure that prevents tangled wire which comprises a first wire extended from a first earplug, a second wire extended from a second earplug, and a third wire which couples with both the first wire and the second wire and connects with an audio plug; the first wire is provided with a first magnet; the second wire is provided with a second magnet/metal member which attracts to the first magnet by magnetic force; the microphone is provided on the first wire between the first ear plug and the first magnet or on the second wire between the second ear plug and the second magnet/metal member; the microphone, the first magnet and the second magnet/metal member are disposed in such a way when the first magnet and the second magnet/metal member are connected to each other by magnetic force, the microphone is at a position above the first magnet and the second magnet/metal member and adjacent to user's mouth.

The present invention has the following advantages and effects compared with the prior art:

1. Reasonable structure and easy operation: The present structure provides magnets (or alternate arrangement of magnets and metal blocks or metal rings or metal coils) which are mutually spaced apart from one another along the wire to wind the wire in an orderly manner by virtue of magnetic attraction between the magnets (or between the magnets and the metal blocks or metal rings or metal coils). To straighten out the wire, it is only required to apply pulling force to two ends of the wire and then pull apart two ends of the wire directly. Therefore, the present structure is very simple and reasonable, and achieves significant tangling prevention effect.

2. Convenient use: The present structure allows very convenient wire winding achievable even only with hands. The wire can be straightened out even more conveniently by pulling apart two ends thereof. The trouble of tangled wire is completely eliminated. Operation of the present structure is quick and easy, and highly efficient. The design of the present invention is also very user-friendly.

3. Good applicability: The present structure is widely applicable to wires of various kinds of household appliances, and more specifically applicable to wires with relatively smaller diameters, such as wires for earphones, chargers and hair dryers. The present invention perfectly solves the problem of easy tangling of these long thin wires.

### BRIEF DESCRIPTION OF THE DRAWINGS

FIG. 1 is a structural diagram of embodiment 1 of the present invention.

FIG. 2 is the structure shown in FIG. 1 during use.

FIG. 3 is a structural diagram of the wire body according to embodiment 1.

FIG. 4 is a structural diagram of the wire body according to embodiment 2.

FIG. 5 is a structural diagram according to embodiment 3.

FIG. 6 is a structural diagram according to embodiment 4.

FIG. 7 is a structural diagram of a wired earphone device of the present invention.

### DETAILED DESCRIPTION OF THE INVENTION

The present invention is described further in detail below with reference to some embodiments and the accompanying drawings. It should be understood that the present invention should not be limited to the embodiments described herein.

### Embodiment 1

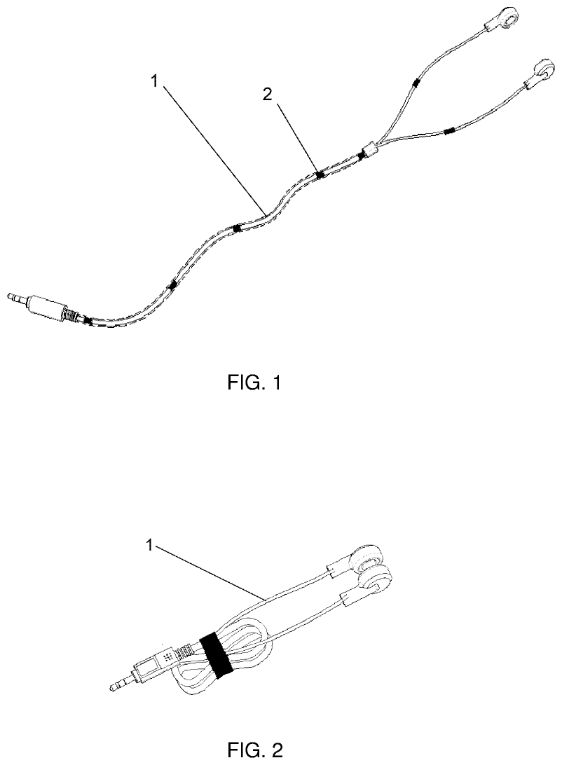

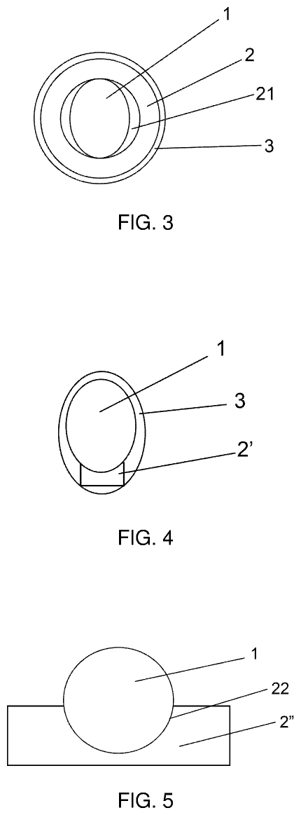

FIGS. 1-3 illustrate a first embodiment of the present invention. As shown in FIG. 1, the structure that prevents tangled wire according to the present invention comprises a wire body 1; the wire body 1 is an earphone wire; seven magnets 2 are evenly provided on the wire body 1. The magnets 2 and the wire body 1 are fixedly connected.

The seven magnets 2 are evenly distributed over the wire body 1. The magnets 2 are magnetic rings. Each of the magnetic rings has a length of 3-8 mm; a distance between two adjacent magnetic rings is preferably 7-26 cm; each of the magnetic rings is provided with a center hole 21; the wire body 1 passes through center holes 21 of the magnets 2 and connects with the magnets 2 by adhesion. Besides, an outer coating layer 3 is provided to wrap the wire body 1 and the magnets 2 such that the earphone wire of the present invention has the same outer appearance as an ordinary earphone wire. The outer coating layer 3 can be made of plastics, rubber or nylon etc.

During use, a user can simply wind the earphone wire around the hand or any object that has a certain length, the earphone wire will then form orderly windings automatically due to mutual magnetic attraction of the magnets, as illustrated by FIG. 2. To straighten out the windings, pull apart two ends of the earphone wire by a slight force sufficient to overcome the magnetic force to fully straighten out the earphone wire. As described, use of the present invention is very quick and simple.

### Embodiment 2

FIG. 4 shows the second embodiment of the present invention. The second embodiment is the same as the first embodiment except that, the magnets 2′ are embodied as magnetic plates, and the wire body 1 is a mobile phone charger wire.

### Embodiment 3

FIG. 5 illustrates still another embodiment of the present invention. In this embodiment, the wire body 1 is a hair dryer wire. Magnetic plates serving as the magnets 2″ are provided equidistantly on the wire body 1. As shown in FIG. 5, each of the magnets 2″ is provided with a slot 22 allowing the wire body 1 to be fitted thereinto and thus fixed in position, and disengaged therefrom for adjustment according to practical needs. This kind of removable connection between the magnets 2″ and the wire body 1 facilitates positional adjustment of the magnets 2″ on the wire body 1 and allows addition or removal of magnets 2″ according to practical needs. Hence, the present embodiment allows the present invention to be used more conveniently and flexibly.

### Embodiment 4

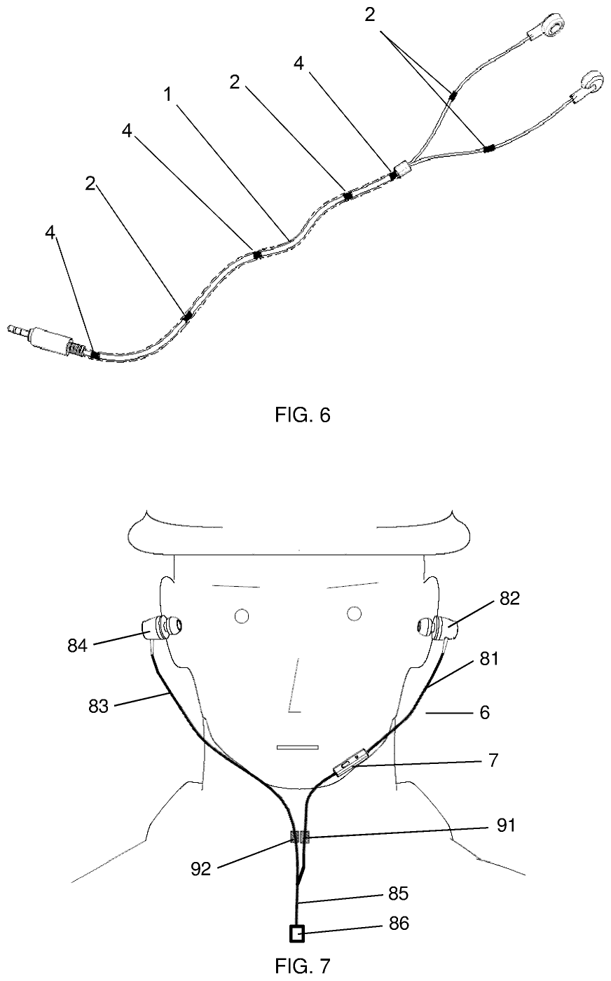

Embodiment 4 is the same as embodiment 1, except as follows: As shown in FIG. 6, apart from the magnetic rings being the magnets 2 disposed on the wire body 1, the wire body is also provided with metal rings 4 that are attractable to the magnetic rings. The metal rings 4 are arranged on the wire body 1 in the same way as how the magnetic rings are arranged on the wire body 1; the metal rings 4 and the magnetic rings are disposed alternately along a length of the wire body, such that any magnetic ring and any one or more metal rings 4 adjacent thereto are mutually attracted.

### Embodiment 5

Embodiment 5 is the similar to embodiment 1, which both comprises a wire body 1. However, in embodiment 5, the wire body is a magnetic wire body which has a covering made of a material being a mixture of magnetic powder and plastic.

### Embodiment 6

As shown in FIG. 7, the wired earphone device 6 with a microphone 7 of embodiment 6 comprises a first wire 81 extended from a first earplug 82, a second wire 83 extended from a second earplug 84, and a third wire 85 which couples with both the first wire 81 and the second wire 83 and connects with an audio plug 86; the first wire 81 is provided with a first magnet 91; the second wire 83 is provided with a second magnet 92 (or in another embodiment could be a metal member instead) which attracts to the first magnet 91 by magnetic force; the microphone 7 is provided on the first wire 81 between the first ear plug 82 and the first magnet 91 (or on the second wire 83 between the second ear plug 84 and the second magnet 92 in another embodiment); the microphone 7, the first magnet 91 and the second magnet 92 are disposed in such a way when the first magnet 91 and the second magnet 92 are connected to each other by magnetic force, the microphone 7 is at a position above the first magnet 91 and the second magnet 92 and adjacent to user's mouth.

The embodiments described above are preferred embodiments of the present invention. It is understood that the present invention should not be limited to the embodiments as described. Any changes, modifications, replacements, combinations and simplification without deviating from the essence and principle of the present invention should be considered alternative configurations that are equally effective and should also fall within the scope of protection of the present invention.

What is claimed is:

1. A structure that prevents tangled wire, comprising a wire body, characterized in that, N magnets are provided on the wire body, wherein N≥1; the magnets are fixedly connected with the wire body.

2. The structure according to claim 1, wherein the magnets are evenly distributed over the wire body, and are fixedly connected with the wire body through adhesion or embedment.

3. The structure according to claim 2, wherein the magnets are removably connected with the wire body when the magnets and the wire body are connected through embedment; a slot is provided on each of the magnets; the wire body is fitted into the slot of each of the magnets so as to be fixed or disengaged therefrom for adjustment.

4. The structure according to claim 1, wherein the magnets are magnetic rings; each of the magnetic rings is provided with a center hole; the wire body passes through center holes of the magnets and connects with the magnetic rings by adhesion.

5. The structure according to claim 4, wherein an outer coating layer is provided to wrap the wire body and the magnetic rings; the outer coating layer is made of plastics, rubber or nylon.

6. The structure according to claim 1, wherein the magnets are magnetic plates; the magnetic plates are connected with the wire body by adhesion.

7. The structure according to claim 6, wherein an outer coating layer is provided to wrap the wire body and the magnetic plates; the outer coating layer is made of plastics, rubber or nylon.

8. The structure according to claim 1, wherein the wire body is a earphone wire, a charger wire, a hair dryer wire, or an electrical wire of a general household appliance.

9. The structure according to claim 1, wherein each of the magnets has a length of 2-20 mm; the magnets are disposed equidistantly on the wire body; a distance between two adjacent magnets is 7-26 cm.

10. The structure according to claim 2, wherein apart from the magnets, the wire body is also provided with metal blocks or metal rings or metal coils that are attractable to the magnets; the metal blocks or metal rings or metal coils are arranged on the wire body in the same way as how the magnets are arranged on the wire body; the metal blocks or metal rings or metal coils and the magnets are disposed alternately along a length of the wire body.

11. A structure that prevents tangled wire, comprising a magnetic wire body.

12. The structure that prevents tangled wire as in claim 11, wherein the magnetic wire body has a covering made of a material being a mixture of magnetic powder and plastic.

13. A wired earphone device with a microphone with the structure that prevents tangled wire as in claim 1, wherein it comprises a first wire extended from a first earplug, a second wire extended from a second earplug, and a third wire which couples with both the first wire and the second wire and connects with an audio plug; the first wire is provided with a first magnet; the second wire is provided with a second magnet/metal member which attracts to the first magnet by magnetic force; the microphone is provided on the first wire between the first ear plug and the first magnet or on the second wire between the second ear plug and the second magnet/metal member; the microphone, the first magnet and the second magnet/metal member are disposed in such a way when the first magnet and the second magnet/metal member are connected to each other by magnetic force, the microphone is at a position above the first magnet and the second magnet/metal member and adjacent to user's mouth.
